(19) United States
(12) Patent Application Publication
(10) Pub. No.: US 2014/0232610 A1
(43) Pub. Date: Aug. 21, 2014

(54) ANTENNA DEVICE

(71) Applicants: Yoko Shigemoto, Chiba (JP); Eiji Hirose, Chiba (JP); Tomoya Ishida, Chiba (JP)

(72) Inventors: Yoko Shigemoto, Chiba (JP); Eiji Hirose, Chiba (JP); Tomoya Ishida, Chiba (JP)

(73) Assignee: Mitsubishi Steel MFG. Co., Ltd., Tokyo (JP)

(21) Appl. No.: 13/982,345

(22) PCT Filed: Jan. 19, 2012
(86) PCT No.: PCT/JP2012/051078

§ 371 Date: Aug. 29, 2013

(30) Foreign Application Priority Data
Feb. 2, 2011 (JP) 2011-021059

(51) Int. Cl. H01Q 1/40

(52) U.S. Cl. CPC H01Q 1/40
USPC 343/873

(57) ABSTRACT

An antenna device includes a first antenna element made of a conductive metallic plate and formed in a shape of a meander; a second antenna element made of another conductive metallic plate and formed in another shape of a meander; and a sealing material which is made of a high-dielectric material and is configured to seal the first and second antenna elements by the sealing material, wherein the first antenna element is arranged in parallel with the second antenna element, and wherein the first and second antenna elements are embedded inside the sealing material by insert molding.

### TECHNICAL FIELD

The present invention relates to an antenna device, particularly to an antenna device operable especially at two frequency bands.

### BACKGROUND ART

In recent years, a portable terminal device typified by a mobile phone is equipped with various communication functions such as a global positioning system (GPS) function, a Bluetooth function, a wireless LAN function, or the like. Communications between various electronic apparatuses are enabled by the functions. An antenna for communications is built into such a portable terminal device. In a portable terminal device having a plurality of communication functions (e.g., two communication functions), two antennas corresponding to these functions are provided. On the other hand, the portable terminal device is required to be thin or compact. Because space efficiency is lowered by individually providing the two antennas, there is proposed an antenna in which the two antennas are integrated (see Patent Document 1).

As a mode of the antenna, a first antenna element is obtained by undergoing pattern formation on a first dielectric substrate. Then, a second antenna element is obtained by undergoing pattern formation on a second dielectric substrate. Thereafter, an antenna device operable in the two frequency bands is substantialized by laminating the first and second dielectric substrates (Patent Document 2 and FIG. 3).

### BACKGROUND ART DOCUMENT

### Patent Documents

[Patent Document 1] Japanese Laid-open Patent Publication No. 2004-228982 (FIG. 1)

[Patent Document 2] Japanese Laid-open Patent Publication No. 2003-124729 (para. [0024], FIG. 3)

### DISCLOSURE OF THE INVENTION

However, in an antenna device formed such that the antenna element undergoes pattern formation on a conventional dielectric substrate and the antenna elements are laminated, there is a problem in that a production capacity becomes excessive and a production cost increases. Further, in the conventional antenna device, the antenna element inevitably has a plane-like structure and is outwardly exposed. Therefore, there is a problem in that good antenna characteristics are hardly obtainable.

### Means for Solving Problems

The embodiments of the present invention are provided in consideration of the above problems. The objects of the antenna device are to improve production efficiency and simultaneously improve characteristics.

One aspect of the embodiment of the present invention may be to provide an antenna device including a first antenna element made of a conductive metallic plate and formed in a shape of a meander; a second antenna element made of another conductive metallic plate and formed in another shape of a meander; and a sealing material which is made of a high-dielectric material and is configured to seal the first and second antenna elements by the sealing material, wherein the first antenna element is arranged in parallel with the second antenna element, and wherein the first and second antenna elements are embedded inside the sealing material by insert molding.

In the above invention, it is preferable that the first and second antenna elements undertake capacitive coupling through the sealing material.

In the above invention, it is preferable that shapes of the first and second antenna elements are the same.

In the above invention, it is preferable that the first antenna element is a GPS antenna, and the second antenna element is a Bluetooth antenna.

### Effect of the Invention

According to an embodiment of the present invention, because the zigzag spring is held inside a space formed by oppositely arranged first and second spring accommodating parts and the zigzag spring is held by inner walls of the first and second spring accommodating parts, it is possible to securely prevent the zigzag spring from buckling and to secure a smooth expanding and contracting action.

### Effect of the Invention

According to the disclosed antenna device, it is possible to improve production efficiency by insert molding. Further, because the first and second antenna elements are embedded in a sealing material made of a high-dielectric material, antenna characteristics can be improved.

### BRIEF DESCRIPTION OF DRAWINGS

Other objects, features, and advantages of the present invention will become more apparent from the following detailed description when read in conjunction with the accompanying drawings.

FIG. 1 is a perspective view of an antenna device of an embodiment of the present invention.

FIG. 2 is a perspective view illustrating first and second antenna elements of an embodiment of the present invention.

FIG. 3 is a perspective view of an antenna device of an embodiment of the present invention.

FIG. 4 is a perspective view illustrating the first and second antenna elements before installing these in a metallic mold.

FIG. 5 is a view for illustrating VSWR characteristics of the antenna device of the embodiment of the present invention.

FIG. 6 illustrates at (A) to (F) directional characteristics of the antenna device of the embodiment of the present invention.

FIG. 7 illustrates a direction of installing in a board.

### BEST MODE FOR CARRYING OUT THE INVENTION

Referring to figures, embodiments of the present invention are described.

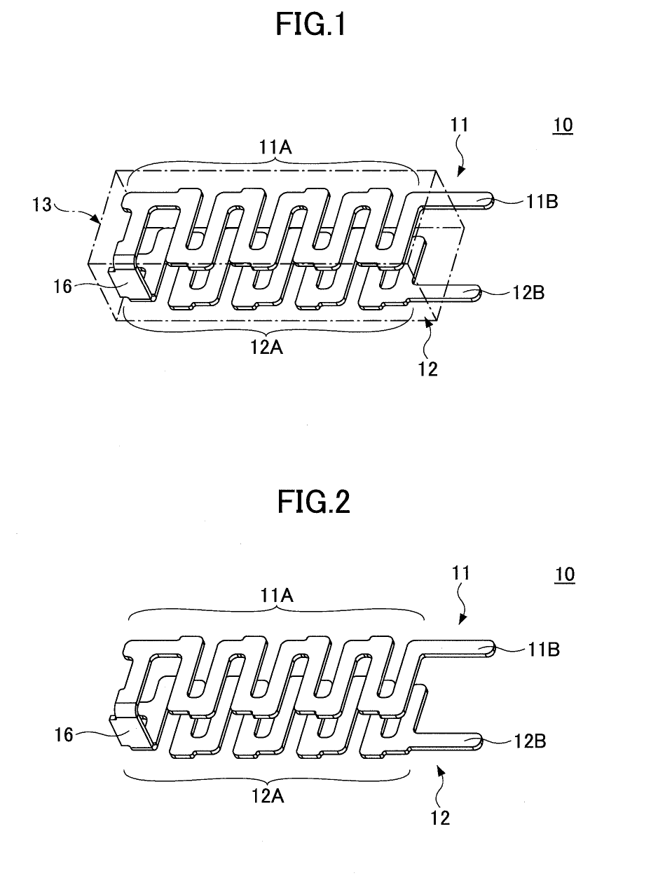

FIG. 1 illustrates an antenna device 10 as an embodiment of the present invention. The antenna device 10 of the embodiment is a double resonance antenna that is operated in two frequency bands. The antenna device 10 is installed in, for example, a portable terminal device such as a mobile phone or the like.

The antenna device 10 is formed by a first antenna element 11, a second antenna element 12, a sealing material 13, or the like.

The first and second antenna elements 11 and 12 are integrally formed by press punching a conductive metallic plate. Within the embodiment, the first antenna element 11 positioned upward is a GPS antenna, and the second antenna 12 positioned downward is a Bluetooth antenna. The shapes of the first and second antenna elements 11 and 12 are the same. However, the shapes of the antenna elements 11 and 12 are not necessarily the same. As described later, it is possible to make the shapes different as long as capacitive coupling can be performed.

Further, as described below, it is necessary to highly accurately position the first and second antenna elements 11 and 12 so that a distance between the first and second antenna elements 11 and 12 becomes a predetermined value. Therefore, a connecting portion 16 is integrally formed between the first and second antenna elements 11 and 12. By this connecting portion 16, the distance between the first and second antenna elements 11 and 12 is maintained to be constant.

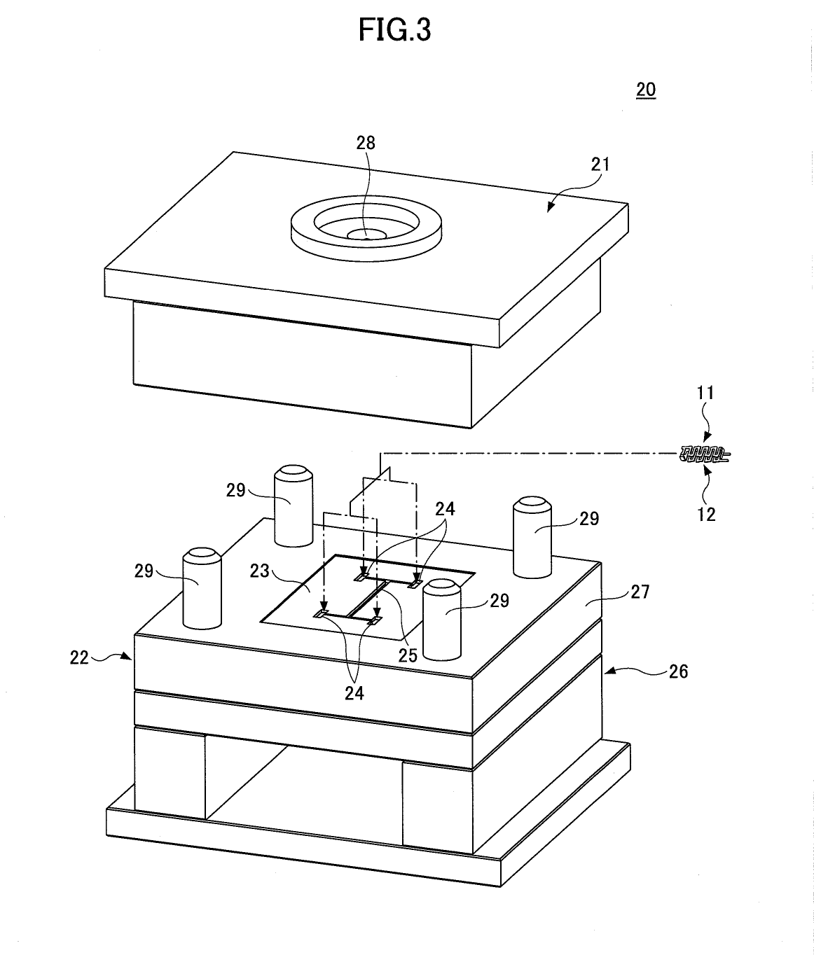

Within the embodiment, the material of the first and second antenna elements 11 and 12 is stainless. However, the material of the first and second antenna elements 11 and 12 is not limited thereto, and may be another material such as copper. When necessary, plating may be provided on the surfaces of the antenna elements 11 and 12. FIG. 2 is an enlarged view of the first and second antenna elements 11 and 12. Referring to FIG. 2, meander portions 11A and 12A, power supply terminal portions 11B and 12B, and the connecting portion 16 are integrally formed. The meander portions 11A and 12A are patterned to be in a zigzag-like shape. By forming the meander portions 11A and 12A as described above, it is possible to miniaturize the antenna device 10 while increasing the substantive length of the antenna. Within the embodiment, the dimensions of the outer shape of the antenna device 10 are 3 mm×10 mm×3.5 mm.

The power supply terminal portion 11B is formed so as to extend from an end portion of the meander portion 11A on one side of the meander portion 11A. The power supply terminal portion 12B is formed so as to extend from an end portion of the meander portion 12A on one side of the meander portion 12A. Referring to FIG. 1, the power supply terminal portions 11B and 12B protrude outside the sealing material 13. These power supply terminal portions 11B and 12B are connected to an electronic circuit inside the portable terminal device. Within the embodiment, the widths of the first and second antenna elements 11 and 12 are 0.5 mm to 2.0 mm.

The sealing material 13 is formed by a high-dielectric resin material. In the high-dielectric resin material used in the embodiment, high-dielectric characteristics are adjusted by adding ceramic powders having a predetermined Q value and a predetermined relative permissibility to, for example, a liquid crystal polymer resin (a LCP resin) thereby adjusting the high-dielectric characteristics. As described, because the sealing material 13 is a high-dielectric resin material, the antenna device 10 can be miniaturized by a wavelength shortening effect.

The relative permissibility of the sealing material 13 is preferably, for example, 4 or greater and 30 or smaller. By setting the relative permissibility of the sealing material 13 within the range, it is possible to miniaturize the antenna device 10 without degrading the antenna characteristics of the sealing material 13. Said differently, if the relative permittivity is smaller than 4, it becomes very difficult to effectively reduce the size (shape) of the sealing material 13. On the contrary, if the relative permittivity exceeds 30, the resonance frequency band is narrowed thereby degrading antenna characteristics.

Although a structure where the sealing material 13 is formed by adding ceramic powders to a resin material is exemplified, the material of the sealing material 13 is not limited thereto. As long as a sealing material can achieve the above relative permissibility, the sealing material can be made of only ceramics or of only a resin.

The above first and second antenna elements 11 and 12 are embedded into the sealing resin 13 by insert molding. FIG. 3 illustrates a metallic mold 20 used in insert molding the first and second antenna elements 11 and 12 inside the sealing material 13.

The metallic mold 20 includes an upper mold 21 and a lower mold 22. The upper mold 21 has a pot 28, in which a plunger (not illustrated) is installed. The upper mold 21 includes a holder base 27 formed on an upper portion of a base 26. A die block 23 is installed in a center portion of the holder base 27. Cavities 24 corresponding to the shape of the antenna device 10 are formed in the die block 23.

Within the embodiment, four cavities 24 are formed in the die block 23. The cavities 24 are connected by a runner 25. The pot 28 is connected with the runner 25 in a state where the upper mold 21 and the lower mold 22 are assembled. Alignment posts 29 are provided to position the upper mold 21 and the lower mold 22.

In order to insert mold the antenna device 10, the first and second antenna elements 11 and 12 are mounted inside the cavities 24. At this time, the first and second antenna elements 11 and 12 are mounted in parallel inside the cavities 24. Further, the antenna elements 11 and 12 are attached to the metallic mold 20 so as to be apart from the inner walls of the cavities 24 while the antenna elements 11 and 12 are mounted in the cavities 24.

After the first and second antenna elements 11 and 12 are mounted in the die block 23, the upper mold 21 is mounted on the lower mold 22. Subsequently, the high-dielectric resin material to be the sealing material 13 is charged into the pot 28 and then the high-dielectric resin material is pressurized by the plunger (not illustrated). The high-dielectric resin material is introduced into the cavities 24 through the runner 25. With this, the antenna device 10, having the structure where the first and second antenna elements 11 and 12 are embedded inside the sealing material 13, is manufactured.

At this time, because the first antenna element 11 and the second antenna element 12 are connected by the connecting portion 16, even if the resin fills the insides of the cavities 24, the distance between the antenna elements 11 and 12 can be maintained to have a predetermined value.

As described, because the antenna device 10 is manufactured by using an insert mold, the production capacity can be smaller than and the production process can be simpler than those in conventional methods where boards are laminated or an antenna element is patterned.

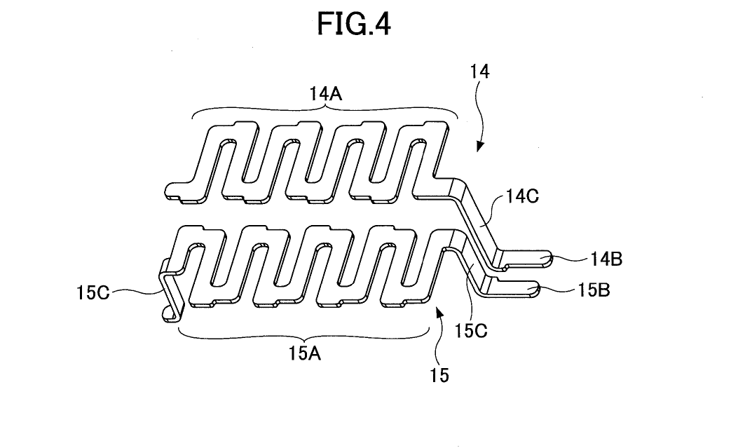

Referring to FIG. 4, a modified example is illustrated where the distance between the antenna elements 14 and 15 is maintained to be a predetermined value. Within the modified example, leg portions 14C and 15C are formed in the antenna elements 14 and 15, respectively. By making the lengths of the leg portions 14C and 15C different, it is possible to maintain the distance between the antenna elements 14 and 15 to be a predetermined value.

Within the modified example illustrated in FIG. 4, only one leg portion 140 is provided at one end portion of the meander portion 14A. A power supply terminal portion 14B is formed on the lower end of the leg portion 14C. Further, the second antenna element 15 has leg portions 15C on both ends of a meander portion 15A. A power supply terminal 15B is integrally formed with one of the leg portions 15C.

Next, the structure of the antenna device 10 produced as described above is explained. As described above, the first and second antenna elements 11 and 12 maintain a parallel arrangement inside the sealing material 13. The sealing material 13 having a high dielectric constant is interposed between the pair of antenna elements 11 and 12.

Thus, the pair of the antenna elements 11 and 12 undertakes capacitive coupling through the sealing material 13. The antenna device 10 of the embodiment uses the capacitive coupling generated between the pair of the antenna elements 11 and 12 to substantialize the antenna device which is operated in two frequency bands.

Said differently, a coupling capacitance is changed by changing the distance between the two antenna elements 11 and 12 having the shapes of meander. In the antenna device of the embodiment, the impedance can be adjusted at an arbitrary frequency by using a relationship between the coupling capacitance and the distance.

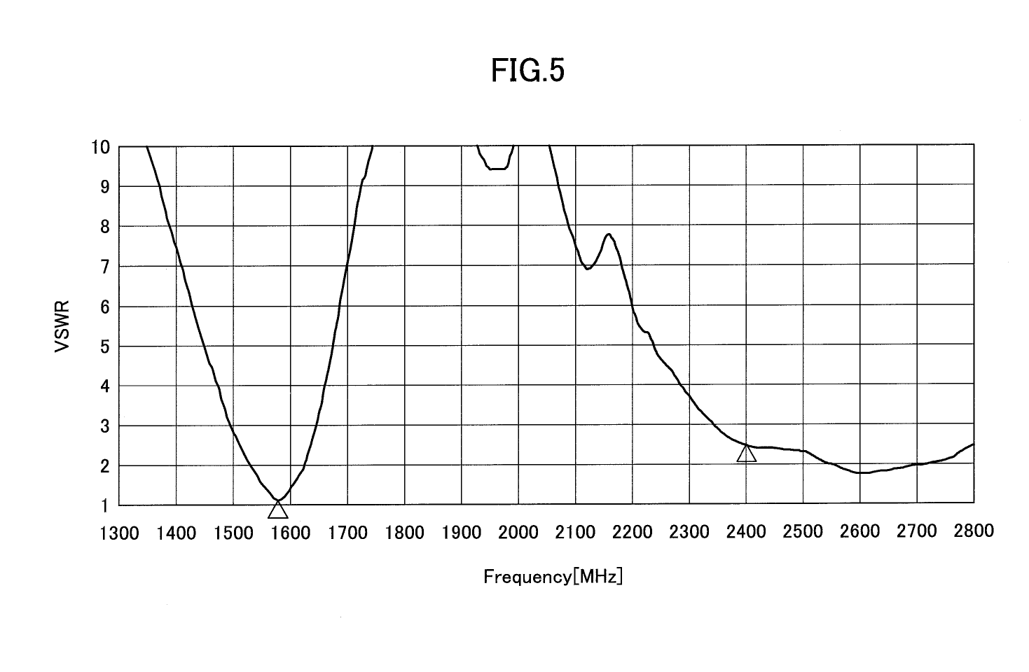

FIG. 5 illustrates voltage standing wave ratio (VSWR) characteristics of the antenna device 10 of the embodiment. Referring to FIG. 5, VSWR is 0.2 in a GPS band (about 1575 MHz) of the antenna device 10, and VSWR is 2.5 in a Bluetooth band (about 2400 MHz) of the antenna device 10. These values of VSWR indicate that the antenna device 10 of the embodiment has a good performance as a small-sized antenna device.

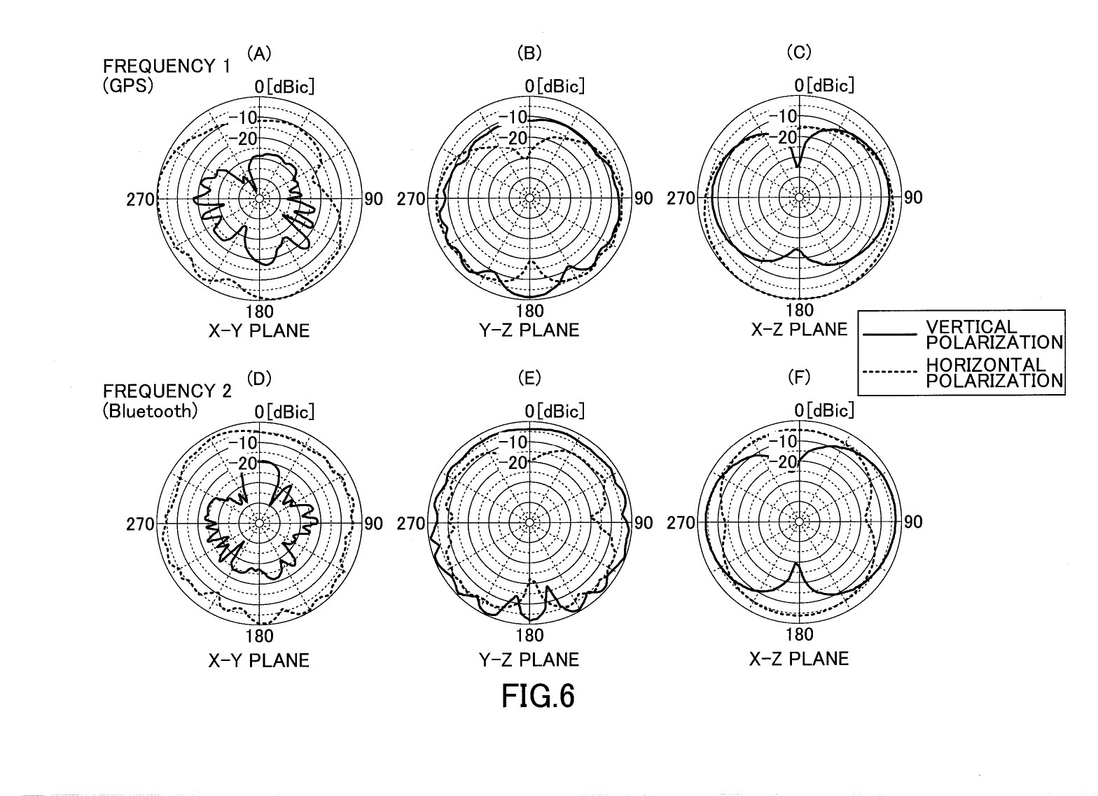

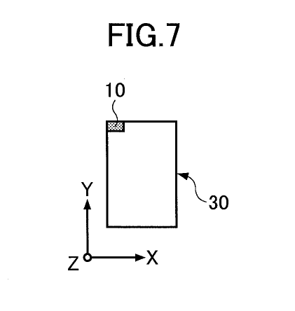

Meanwhile, FIG. 6 illustrates directional characteristics of the antenna device 10. The measuring method of measuring the directional characteristics is as illustrated in FIG. 7. The antenna device 10 is installed on a board 30 having a predetermined shape, for example, an ordinary board shape used for a mobile phone.

Referring to FIG. 6, at (A) to (F), results of measuring an antenna gain and a radiation directivity for the antenna device 10 (see FIG. 1) are illustrated. Further, in this measurement, two propagation frequencies are used. Specifically, a first frequency (frequency 1) corresponding to GPS and a second frequency (frequency 2) corresponding to Bluetooth are used as the frequency of measuring the characteristics. Referring to FIG. 6, (A) illustrates the characteristics on the X-Y plane of the frequency 1, (B) illustrates the characteristics on the Y-Z plane of the frequency 1, and (C) illustrates the characteristics on the X-Z plane of the frequency 1. Referring to FIG. 6, (D) illustrates the characteristics on the X-Y plane of the frequency 2, (E) illustrates the characteristics on the Y-Z plane of the frequency 2, and (F) illustrates the characteristics on the X-Z plane of the frequency 2. Please refer to FIG. 7 with respect to the directions of X, Y, and Z. In every measurement of the directional characteristics, vertical polarization components and horizontal polarization components were measured.

As to the characteristics of the frequency 1 on the X-Y plane, the gain in the vertical polarization is low and the gain in the horizontal polarization is high and omnidirectional. As to the characteristics of the frequency 1 on the Y-Z plane and the X-Z plane, the gains in both of the vertical polarization and the horizontal polarization are high and omnidirectional.

The characteristics of the frequency 2 are substantially similar to those of the frequency 1. Even though the gain on the X-Y plane in the vertical polarization is low, the gains in the horizontal polarization are high and omnidirectional. As to the characteristics of the frequency 2 on the Y-Z plane and the X-Z plane, the gains in both of the vertical polarization and the horizontal polarization are high and omnidirectional.

According to the results illustrated in (A) to (F) of FIG. 6, the antenna device of the embodiment is proved to be an antenna having high gains and being excellent in omnidirectional characteristics.

Although the invention has been described with respect to specific embodiments for a complete and clear disclosure, the appended claims are not to be thus limited but are to be construed as embodying all modifications and alternative constructions that may occur to one skilled in the art that fairly fall within the basic teachings herein set forth.

This patent application is based on Japanese Priority Patent Application No. 2011-021059 filed on Feb. 2, 2011, entire contents of which are hereby incorporated herein by reference.

### EXPLANATION OF REFERENCE SYMBOLS

10: antenna device
11,14: first antenna element
12,15: second antenna element
11A,12A,14A,15A: meander portion
11B,12B,14B,15B: power supply terminal portion
13: sealing material
16: connecting portion
20: metallic mold
24: cavity

1. An antenna device comprising:
a first antenna element made of a conductive metallic plate and formed in a shape of a meander;
a second antenna element made of another conductive metallic plate and formed in another shape of a meander; and
a sealing material which is made of a high-dielectric material and is configured to seal the first and second antenna elements by the sealing material,
wherein the first antenna element is arranged in parallel with the second antenna element, and
wherein the first and second antenna elements are embedded inside the sealing material by insert molding.

2. The antenna device according to claim 1,
wherein the first and second antenna elements undertake capacitive coupling through the sealing material.

3. The antenna device according to claim 1,
wherein shapes of the first and second antenna elements are the same.

4. The antenna device according to claim 1,
wherein the first antenna element is a GPS antenna, and
wherein the second antenna element is a Bluetooth antenna.
